(19) United States
(12) Patent Application Publication
(10) Pub. No.: US 2025/0278224 A1
(43) Pub. Date: Sep. 4, 2025

(54) IMAGE FORMING APPARATUS, CONTROL METHOD, AND STORAGE MEDIUM

(71) Applicant: Masahiro SHIRATORI, Kanagawa (JP)

(72) Inventor: Masahiro SHIRATORI, Kanagawa (JP)

(21) Appl. No.: 19/064,749

(22) Filed: Feb. 27, 2025

(30) Foreign Application Priority Data
Mar. 4, 2024 (JP) 2024-032132

(51) Int. Cl. G06F 3/12; H04N 1/00

(52) U.S. Cl. CPC G06F 3/123; G06F 3/1204; H04N 1/00408; H04N 1/00477

(57) ABSTRACT

An image forming apparatus includes a main body, an operating device, a management microcomputer, and a display. The main body performs image forming operation. The operating device receives a user operation. The management microcomputer is communicably connected to the main body and the operating device. The display displays an update state of firmware of the main body and an update state of firmware of the operating device. When at least one of the firmware of the main body and the firmware of the operating device is being updated, the management microcomputer receives information indicating the update state of the at least one of the firmware of the main body and the firmware of the operating device that is being updated and controls displaying operation of the display based on the update state indicated by the information.

### CROSS-REFERENCE TO RELATED APPLICATIONS

This patent application is based on and claims priority pursuant to 35 U.S.C. §119(a) to Japanese Patent Application No. 2024-032132, filed on Mar. 4, 2024, in the Japan Patent Office, the entire disclosure of which is hereby incorporated by reference herein.

### BACKGROUND

### Technical Field

The present disclosure relates to an image forming apparatus, a control method, and a storage medium.

### Related Art

In an image forming apparatus such as a multifunction peripheral (MFP), firmware used in a main control unit and an operation control unit of the MFP is usually updated as appropriate.

For example, a technique has been proposed in which, when a firmware update process of updating a firmware used in an operation control unit is executed, a main control unit displays at least one of information indicating a progress status of the firmware update process and information indicating a result of the firmware update process on a display unit without using the operation control unit.

### SUMMARY

Embodiments of the present disclosure described herein provide a novel image forming apparatus including a main body, an operating device, a management microcomputer, and a display. The main body performs image forming operation. The operating device receives a user operation. The management microcomputer is communicably connected to the main body and the operating device. The display displays an update state of firmware of the main body and an update state of firmware of the operating device. When at least one of the firmware of the main body and the firmware of the operating device is being updated, the management microcomputer receives information indicating the update state of the at least one of the firmware of the main body and the firmware of the operating device that is being updated and controls displaying operation of the display based on the update state indicated by the information.

Embodiments of the present disclosure described herein provide a novel control method for controlling an image forming apparatus including a main body, an operating device, a management microcomputer, and a display. The main body performs image forming operation. The operating device receives a user operation. The management microcomputer is communicably connected to the main body and the operating device. The display displays an update state of firmware of the main body and an update state of firmware of the operating device. The method includes: when at least one of the firmware of the main body and the firmware of the operating device is being updated, receiving information indicating the update state of the at least one of the firmware of the main body and the firmware of the operating device that is being updated; and when at least one of the firmware of the main body and the firmware of the operating device is being updated, controlling displaying operation of the display based on the update state indicated by the information.

Embodiments of the present disclosure described herein provide a novel non-transitory storage medium storing computer-readable program code that, when executed by a computer, causes the computer to perform a method of controlling an image forming apparatus including a main body, an operating device, a management microcomputer, and a display. The main body performs image forming operation. The operating device receives a user operation. The management microcomputer is communicably connected to the main body and the operating device. The display displays an update state of firmware of the main body and an update state of firmware of the operating device. The method includes: when at least one of the firmware of the main body and the firmware of the operating device is being updated, receiving information indicating the update state of the firmware that is being updated; and when at least one of the firmware of the main body and the firmware of the operating device is being updated, controlling displaying operation of the display based on the update state indicated by the information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a hardware configuration of an MFP according to a first embodiment of the present disclosure;

FIG. 2 is a diagram illustrating a display mounted on an operating device;

FIG. 3 is a functional block diagram of a functional configuration of a management microcomputer;

FIGS. 4A to 4C are diagrams illustrating display contents displayed on a display;

FIG. 5 is a flowchart of a firmware update procedure;

FIG. 6 is a block diagram illustrating a hardware configuration of an MFP according to a second embodiment of the present disclosure;

FIG. 7 is a diagram illustrating a hardware configuration of an MFP according to a third embodiment of the present disclosure; and

FIG. 8 is a diagram illustrating a hardware configuration of an MFP according to a fourth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an image forming apparatus, a control method, and a storage medium according to embodiments in detail with reference to the drawings. In the following description, an MFP, which is an aspect of an image forming apparatus, is described as an example of the apparatus according to the present disclosure. However, the apparatus is not limited to the MFP. The MFP is an apparatus having multiple different functions such as a copy function, a scanner function, a print function, and a facsimile function.

### First Embodiment

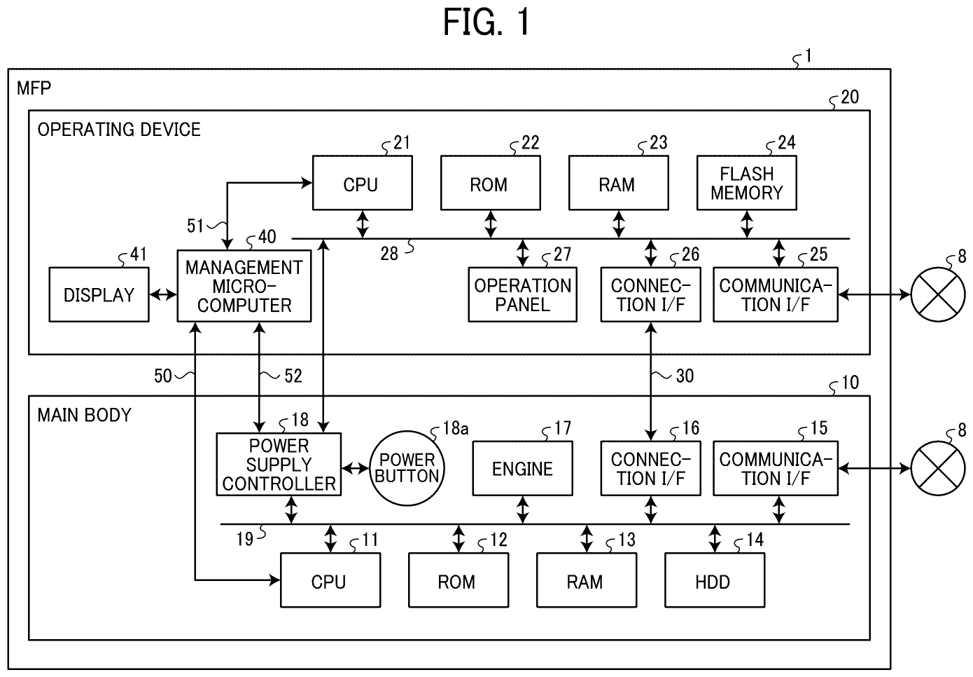

FIG. 1 is a block diagram illustrating a hardware configuration of an MFP 1 according to a first embodiment of the present disclosure. As illustrated in FIG. 1, the MFP 1 includes a main body 10 that implement various functions including image forming, such as a copy function, a scanner function, a facsimile function, and a print function to perform image forming operation, and an operating device 20 that receives user operations. Receiving user operations is a concept including receiving information (including a signal indicating a coordinate value of a screen) input in accordance with a user operation. The main body 10 and the operating device 20 are communicably connected to each other through a dedicated communication path 30. The communication path 30 may be, for example, a communication path that employs a universal serial bus (USB) standard. Alternatively, the communication path 30 may be a communication path that employs any standard regardless of whether the standard is wired or wireless.

The main body 10 performs an operation in accordance with an operation received by the operating device 20. The main body 10 can also communicate with an external device such as a client personal computer (PC) and can perform an operation in accordance with an instruction received from the external device.

A description is given below of a hardware configuration of the main body 10. As illustrated in FIG. 1, the main body 10 includes a central processing unit (CPU) 11, a read-only memory (ROM) 12, a random-access memory (RAM) 13, a hard disk drive (HDD) 14, a communication interface (I/F) 15, a connection I/F 16, an engine 17, and a power supply controller 18, which are connected to each other via a system bus 19.

The CPU 11 controls the overall operation of the main body 10. The CPU 11 executes programs stored in the ROM 12 or the HDD 14, using the RAM 13 as a work area to control the operations of the overall main body 10 and implement various functions, such as a copy function, a scanner function, a print function, and a facsimile function.

The communication I/F 15 is an interface for connecting the main body 10 to a network 8. The connection I/F 16 is an interface for communicating with the operating device 20 via the communication path 30.

The engine 17 is hardware that performs general-purpose information processing and processing other than communication for implementing the copy function, the scanner function, the facsimile function, and the print function. The MFP 1 includes, for example, a scanner that scans and reads an image of an original document, a plotter (image forming unit) that performs printing on a sheet material such as a sheet of paper, and a facsimile that performs facsimile communication. The MFP 1 may further include an optional device such as a finisher that sorts printed sheet materials or an automatic document feeder (ADF) that automatically feeds an original document.

The power supply controller 18 supplies power to each unit of the MFP 1 and controls the activation and shutdown of the MFP 1. A power button 18a is connected to the power supply controller 18. When the user presses the power button 18a of the MFP 1 in a state where the MFP 1 is not activated (the MFP 1 is shut down), the MFP 1 is activated. When the user presses the power button 18a of the MFP 1 in a state where the MFP 1 is activated, the MFP 1 is shut down. When the MFP 1 is shut down, the power supply controller 18 shuts down the main body 10 and also shuts down the operating device 20.

A description is given below of a hardware configuration of the operating device 20. As illustrated in FIG. 1, the operating device 20 includes a CPU 21, a ROM 22, a RAM 23, a flash memory 24, a communication I/F 25, a connection I/F 26, and an operation panel 27, which are connected to each other via a system bus 28. The operating device 20 includes a management microcomputer 40 and a display 41 connected to the management microcomputer 40.

The CPU 21 controls the overall operation of the operating device 20. The CPU 21 executes programs stored in the ROM 22 or the flash memory 24, using the RAM 23 as a work area to control the entire operations of the operating device 20 and implement various functions described below such as display of information (image) according to an input received from the user. Instead of the CPU 21, a system-on-a-chip (SoC) may comprehensively control the operation of the operating device 20.

The communication I/F 25 is an interface for connecting the operating device 20 to the network 8. The connection I/F 26 is an interface for communicating with the main body 10 via the communication path 30.

The operation panel 27 receives various inputs according to user's operations, and displays various information (e.g., information according to the received operation, information indicating an operation state of the MFP 1, and information indicating a setting state). The operation panel 27 is, but not limited to, a liquid crystal display (LCD) having a touch panel function. For example, the operation panel 27 may include an organic electroluminescence (EL) display having a touch panel function. In addition to or instead of the above-described operation panel 27, an operation device such as a hardware key or a display device such as a lamp may be provided.

The management microcomputer 40 is connected to the CPU 11, the CPU 21, and the power supply controller 18 via dedicated signal lines 50, 51, and 52, respectively. When the firmware of the main body 10 or the operating device 20 is updated, the management microcomputer 40 controls the display of the display 41 and the operation of the power supply controller 18. The display 41 includes indicators such as multiple light-emitting diodes (LEDs) or lamps, and is controlled to be turned on, blink, or turned off by the management microcomputer 40 according to an update state of the firmware.

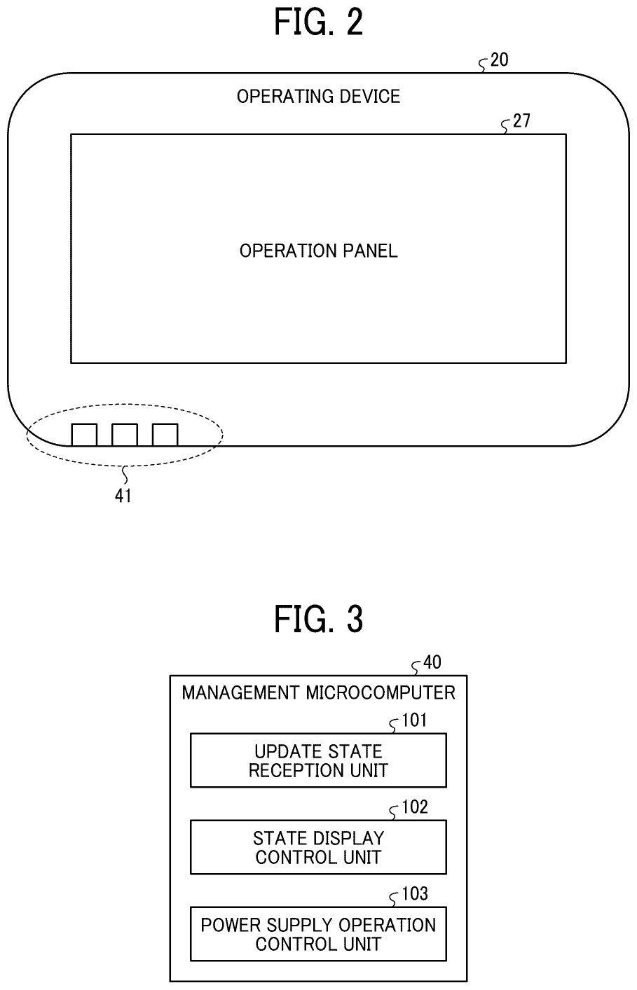

FIG. 2 is a diagram illustrating the display 41 mounted on the operating device 20. The operation panel 27 is disposed at the center of the operating device 20, and the display 41 including three indicators is disposed at a lower left portion of the operating device 20. However, the display 41 may be disposed at another portion as long as the user can easily visually recognize the display 41. For example, the display 41 may be disposed at the lower right or the upper left of the operating device 20. The number of indicators of the display 41 may be other than three, and the display 41 may include a display screen such as a liquid crystal display (LCD) panel in addition to the indicators.

The signal lines 50, 51, and 52 used for connecting the CPU 11, the CPU 21, and the power supply controller 18 to the management microcomputer 40 are independent of the signal lines used for connecting the CPU 11, the CPU 21, and the power supply controller 18 to the system buses 19 and 28 and the signal line used for the communication path 30. Accordingly, even if an abnormality occurs in the main body 10 or the operating device 20, the management microcomputer 40 can operate independently, and can control display on the display 41 and control the operation of the power supply controller 18.

FIG. 3 is a block diagram of a functional configuration of the management microcomputer 40 according to the first embodiment of the present disclosure. As illustrated in FIG. 3, the management microcomputer 40 executes programs related to a firmware update process to implement the functions of an update state reception unit 101, a state display control unit 102, and a power supply operation control unit 103.

When the firmware of the main body 10 or the operating device 20 is being updated, the update state reception unit 101 receives information indicating the update state of the firmware from each of the main body 10 and the operating device 20 via the dedicated signal lines 50 and 51. The update state includes “during update” and “normal end.” The update state reception unit 101 performs receiving processing at regular time intervals to check whether the update state has been transmitted to the management microcomputer 40. The information indicating the update state of the firmware of the main body 10 is transmitted to the management microcomputer 40 without passing through the operating device 20, and the information indicating the update state of the firmware of the operating device 20 is transmitted to the management microcomputer 40 without transmitting through the main body 10. Then, the update state reception unit 101 receives these pieces of information.

The state display control unit 102 determines the update state of the firmware based on the update state received from each of the main body 10 and the operating device 20, and controls the display of the display 41. When the received update state is “during update”, the state display control unit 102 determines that the firmware is being updated. When the received update state is “normal end”, and the state display control unit 102 determines that the firmware update has been normally ended. When the update state reception unit 101 does not receive the update state for a predetermined time (when the main body 10 or the operating device 20 does not transmit the update state to the management microcomputer 40), the state display control unit 102 determines that an abnormality has occurred during the update of the firmware.

When the display 41 includes an indicator indicating the update state of the firmware of the main body 10 and an indicator indicating the update state of the firmware of the operating device 20, each indicator is controlled to turn on, blink, or turn off according to the update state of each firmware. When the display 41 includes a display screen such as an LCD, the state display control unit 102 may control the display 41 so that the update state of each firmware is displayed by characters or icons.

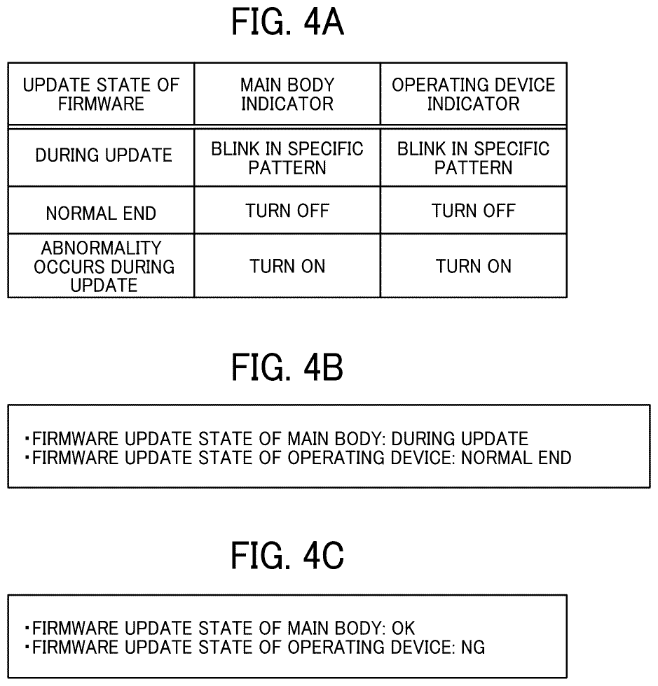

FIGS. 4A to 4C are diagrams illustrating display contents displayed on the display 41. In FIG. 4A, the display 41 includes an indicator (a main body indicator) indicating the update state of the firmware of the main body 10 and an indicator (an operating device indicator) indicating the update state of the firmware of the operating device 20. For example, when the firmware of the main body 10 is being updated, the main body indicator blinks in a specific pattern. When the update has normally ended, the main body indicator turns off. When an abnormality occurs during the update, the main body indicator turns on. The specific pattern used for the blinking of the indicator may be a pattern in which the indicator is repeatedly turned on and off at a constant period. Alternatively, the specific pattern may be a pattern in which the blinking period at the start of the update is different from the blinking period before the end of the update. For example, the state display control unit 102 may shorten the period before the end of the update (or prolong) than the period at the start of the update to present to the user the progress of the update. The state display control unit 102 may turn off the display 41 after continuously blinking the display 41 for a predetermined time. Alternatively, the state display control unit 102 may continuously blink the display 41 until the update state changes from the state of “during update.” Although the display definitions of the main body indicator and the operating device indicator are the same in FIG. 4A, the display definitions of the main body indicator and the operating device indicator may be different.

When the display 41 includes a display screen such as an LCD, FIGS. 4B and 4C are images illustrating the update state of the firmware displayed on the display screen. In this case, the update state of each firmware is displayed by characters or symbols. FIG. 4B illustrates that the firmware of the main body 10 is being updated and the firmware of the operating device 20 has normally ended by sentences. FIG. 4C illustrates that the firmware update state of the main body 10 is “OK” (normal end), and the firmware update state of the operating device 20 is “NG” (abnormality occurrence). The update state may be displayed using figures or icons instead of the symbols as illustrated in FIG. 4C. The display 41 may display an explanatory diagram or explanatory text of each indicator and the degree of progress of the update. For example, the explanatory text includes which of the indicators mounted on the display 41 indicates the update state of the main body 10 and which indicates the update state of the operating device 20.

When the firmware of the main body 10 or the operating device 20 is being updated, the power supply operation control unit 103 controls the operation of the power supply controller 18 via the dedicated signal line 52. For example, when the state display control unit 102 determines that at least one firmware is being updated, the power supply operation control unit 103 controls the power supply controller 18 so that the MFP 1 is not shut down even if the power button 18a is pressed by mistake.

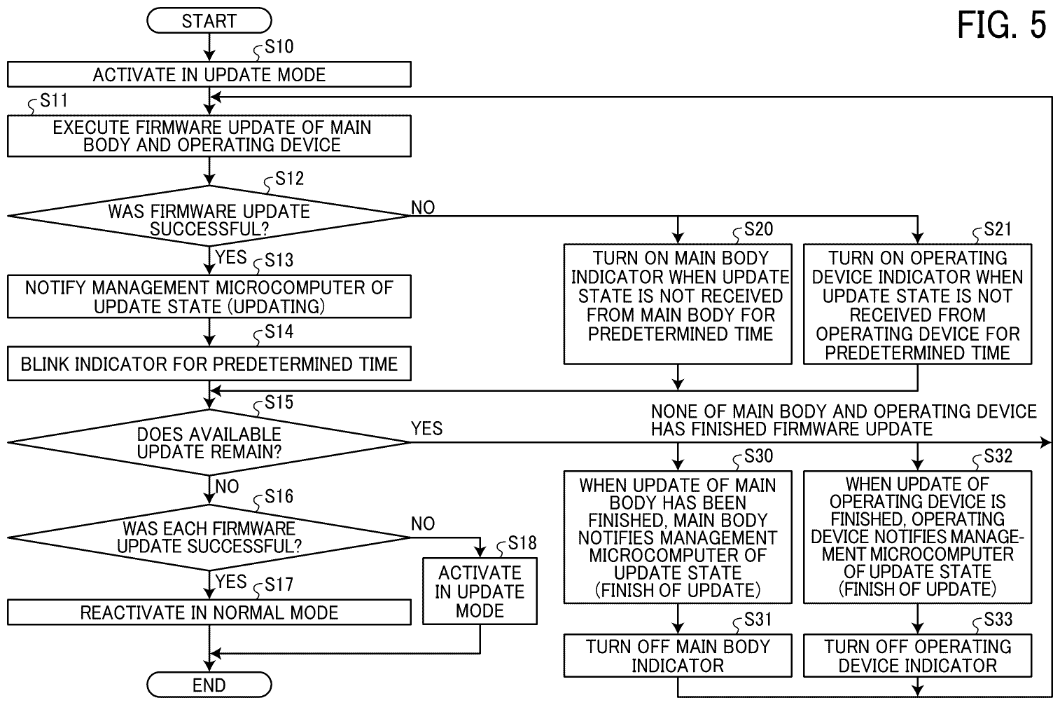

FIG. 5 is a flowchart of a firmware update procedure according to the first embodiment of the present disclosure. In step S10, the MFP 1 is activated in a mode (update mode) for updating firmware. In step S11, the firmware update of the main body 10 and the operating device 20 is executed. In this case, since there is a case where the firmware update is available for only one of the main body 10 and the operating device 20 or a case where the firmware update is available for both of the main body 10 and the operating device 20 but can be executed one by one due to the setting of the MFP 1, the firmware update may be executed only on the main body 10 or only on the operating device 20.

Subsequently, when the update of each firmware has succeeded (YES in step S12), in step S13, the update state reception unit 101 of the management microcomputer 40 is notified of each update state via the dedicated signal lines 50 and 51. In step S14, the state display control unit 102 blinks the main body indicator or the operating device indicator in a specific pattern for a predetermined time. Subsequently, in step S15, it is checked whether an update of each firmware remains. In the firmware update, since multiple versions of the firmware may be collectively available, for example, the version 2.3.1 of the firmware is updated in step S15, and it is checked whether an available update (e.g., version 2.3.2 or 2.3.3) remains in step S15.

When no firmware to be updated remains (NO in step S15) and all the updates have succeeded (YES in step S16), in step S17, the MFP 1 is restarted in the normal mode. When there is an update that has not succeeded (NO in step S16), in step S18, the MFP 1 is restarted in the update mode.

On the other hand, when any of the updates has not succeeded (NO in step S12), the update state reception unit 101 continues the receiving processing at regular time intervals. When the update state is not received from the main body 10 for a predetermined time, in step S20, the main body indicator is turned on. When the update state is not received from the operating device 20 for a predetermined time, in step S21, the operating device indicator is turned on. In this case, since it is determined that an abnormality has occurred in the update in either the main body 10 or the operating device 20, the processing in step S15 and the subsequent steps is executed for the main body 10 or the operating device 20 in which the update has succeeded. The indicator that has been turned on is turned off when the MFP 1 is restarted next time.

In step S15, when the firmware to be updated remains (YES in step S15), the process returns to step S11. At this time, when the update of the main body 10 has finished, in step S30, the main body 10 notifies the management microcomputer 40 of the update state indicating the completion of the update. In step S31, the state display control unit 102 turns off the main body indicator. When the update of the operating device 20 has finished, in step S32, the operating device 20 notifies the management microcomputer 40 of the update state indicating the completion of the update. In step S33, the state display control unit 102 turns off the operating device indicator. When none of the main body 10 and the operating device 20 has finished the firmware update, the process returns to step S11.

As described above, according to the present embodiment, the management microcomputer 40 receives the update state by using the dedicated signal lines 50 and 51 that do not pass through the main body 10 or the operating device 20. Thus, even when an abnormality occurs in the main body 10 or the operating device 20, the update state of the firmware can be displayed on the display 41 and presented to the user. Even if the user presses the power button 18a by mistake during the firmware update, the MFP is not shut down and the firmware update process can be continued. As a result, this configuration enhances the convenience for the user.

### Second Embodiment

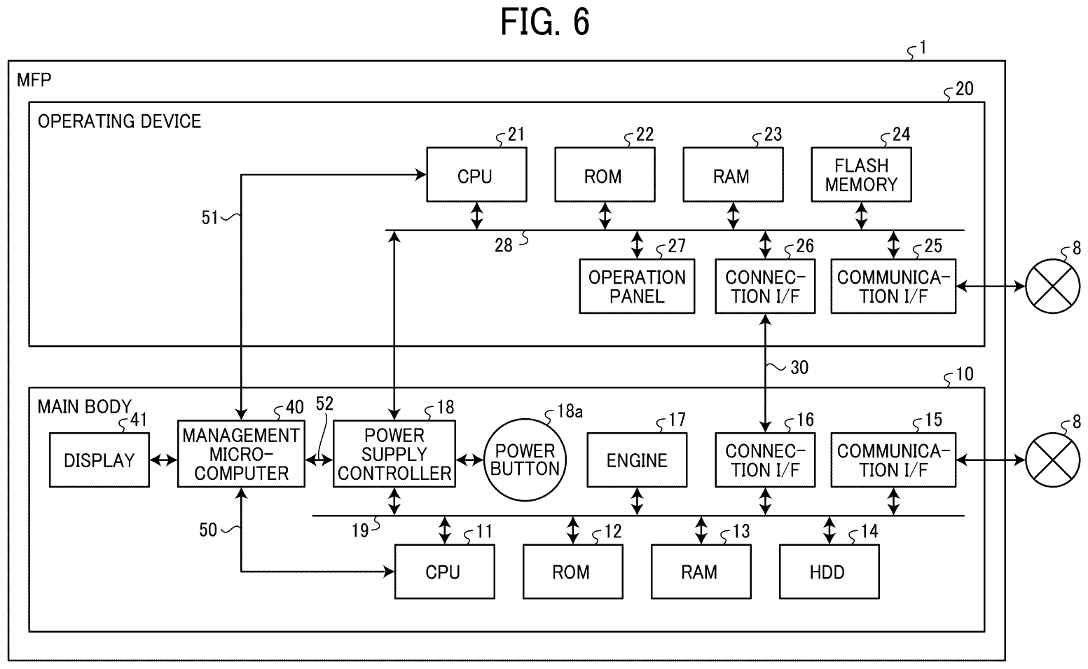

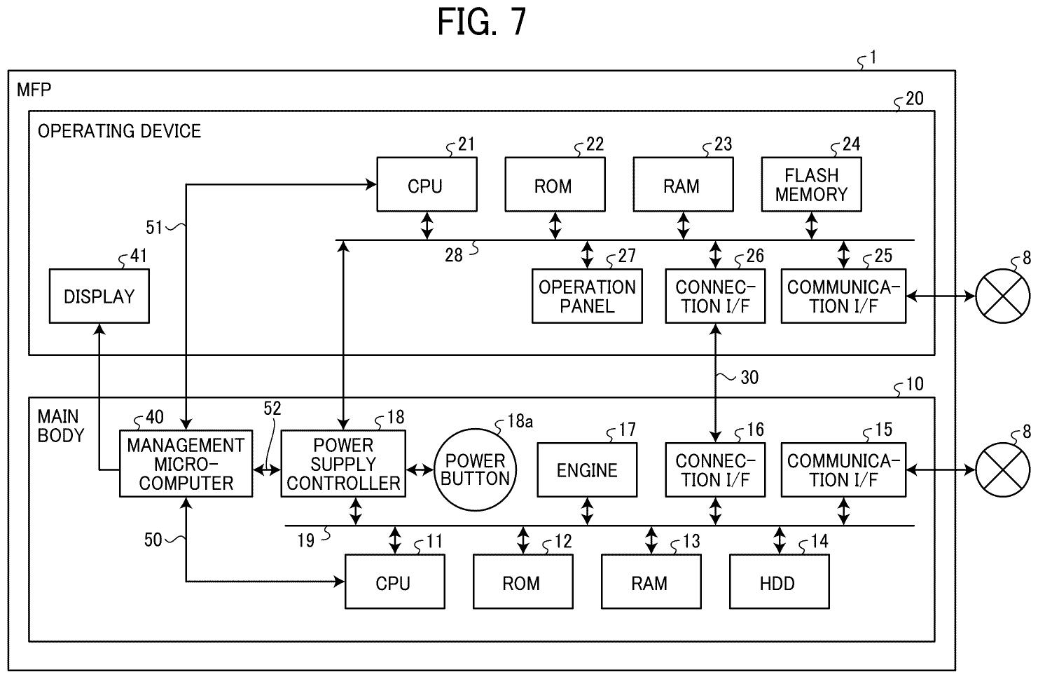

FIG. 6 is a block diagram illustrating a hardware configuration of the MFP 1 according to a second embodiment of the present disclosure. The difference from the first embodiment is that the management microcomputer 40 and the display 41 are included in the main body 10 instead of the operating device 20. Since the operation of each unit, the functional configuration, and the firmware update procedure are the same as those in the first embodiment, descriptions thereof are omitted below.

As described above, according to the present embodiment, since the management microcomputer 40 and the display 41 for displaying the update state are mounted on the main body 10, the operating device 20 can be implemented in a compact manner. In the case where the indicator of the main body 10 is more easily visually recognized than the operating device 20 depending on the installation location of the MFP 1, the convenience of the user can be enhanced.

### Third Embodiment

FIG. 7 is a diagram illustrating a hardware configuration of the MFP 1 according to a third embodiment of the present disclosure. The difference from the first embodiment is that the management microcomputer 40 is included in the main body 10 instead of the operating device 20. Since the operation of each unit, the functional configuration, and the firmware update procedure are the same as those in the first embodiment, descriptions thereof are omitted below.

As described above, according to the present embodiment, since the management microcomputer 40 is mounted on the main body 10, the operating device can be implemented in a compact manner. In a case where the indicator of the operating device 20 is more easily visually recognized than the main body depending on the installation location of the MFP 1, the convenience of the user can be enhanced.

### Fourth Embodiment

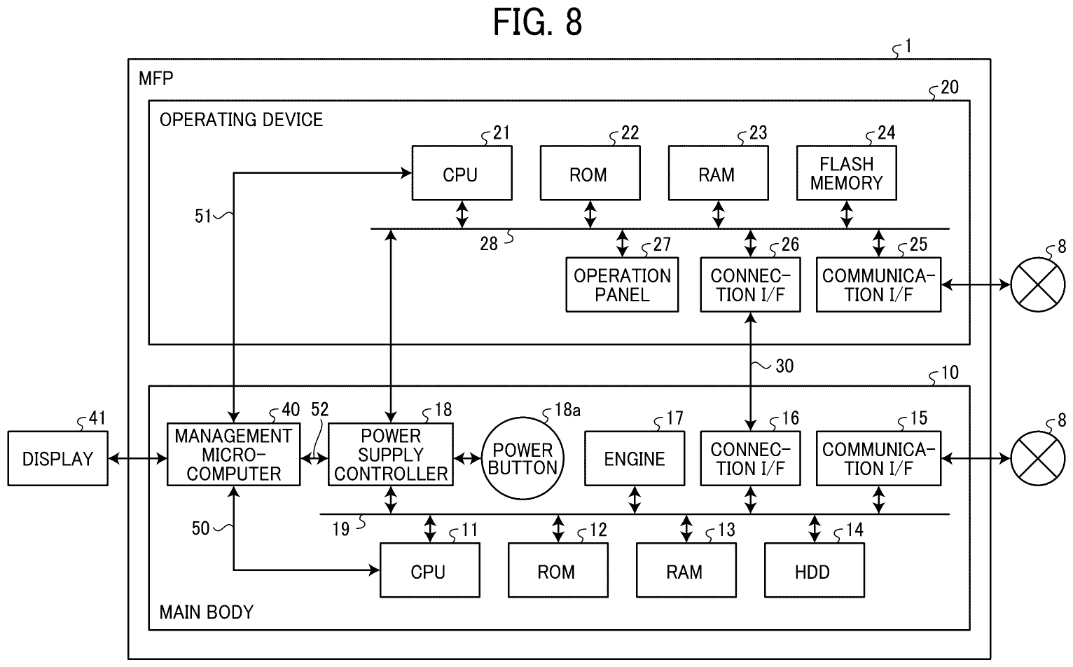

FIG. 8 is a diagram illustrating a hardware configuration of the MFP 1 according to a fourth embodiment of the present disclosure. The difference from the first embodiment is that the management microcomputer 40 is included in the main body 10 instead of the operating device 20, and the display 41 is connected to the management microcomputer 40 from the outside of the MFP 1. Since the operation of each unit, the functional configuration, and the firmware update procedure are the same as those in the first embodiment, descriptions thereof are omitted below.

The display 41 may be, for example, an external device including only an LED indicator. Alternatively, the display 41 may be a device such as a smartphone or a tablet terminal that can communicate with the management microcomputer 40.

As described above, according to the present embodiment, since the management microcomputer 40 is mounted on the main body 10, the operating device 20 can be implemented in a compact manner. Even when it is difficult to visually recognize the main body of the MFP 1 or the indicator of the operating device 20, the update state displayed on the display unit can be checked at a preferable place of the user. As a result, this configuration enhances the convenience for the user.

The present invention is not limited to the above-described embodiments as they are, and constituent elements can be modified and embodied in the practical stage without departing from the gist thereof. Various modifications and variations can be formed by appropriately combining multiple constituent elements disclosed in the above-described embodiments. For example, some constituent elements may be deleted from all the constituent elements described in the above-described embodiments.

The functions of the management microcomputer 40 (i.e., the update state reception unit 101, the state display control unit 102, and the power supply operation control unit 103) described above are implemented by executing a program operated by the management microcomputer 40. However, the present invention is not limited thereto, and at least a part of the functions may be implemented by a dedicated hardware circuit (e.g., a semiconductor integrated circuit).

In the above-described embodiment, the main body 10 and the operating device 20 operate independently of each other on different operation systems. However, the present invention is not limited to this, and for example, the main body 10 and the operating device 20 may operate on the same operation system.

The program executed in the above-described embodiments may be stored in a computer-readable recording medium such as a compact disc read-only memory (CD-ROM), a flexible disk (FD), a compact disc recordable (CD-R), a digital versatile disk (DVD), and a USB in an installable or executable file format, to be provided. Alternatively, the program may be provided or distributed via a network such as the Internet. The program may also be provided with the program embedded in advance in a ROM.

A description is given below of some aspects of the present disclosure.

### Aspect 1

An image forming apparatus includes a main body, an operating device, a management microcomputer, and a display. The main body can implement image forming function. The operating device receives a user operation. The management microcomputer is communicably connected to the main body and the operating device. The display displays an update state of firmware of the main body and an update state of firmware of the operating device. When at least one of the firmware of the main body and the firmware of the operating device is being updated, the management microcomputer receives information indicating the update state of the at least one of the firmware of the main body and the firmware of the operating device and controls display of the display based on the update state indicated by the information.

### Aspect 2

In the image forming apparatus according to Aspect 1, the management microcomputer controls shutdown of the main body based on the update state.

### Aspect 3

In the image forming apparatus according to Aspect 1 or Aspect 2, the main body and the operating device are directly connected to the management microcomputer by dedicated signal lines. Information indicating an update state of the firmware of the main body is transmitted to the management microcomputer without passing through the operating device, and information indicating an update state of the firmware of the operating device is transmitted to the management microcomputer without passing through the main body.

### Aspect 4

In the image forming apparatus according to any one of Aspects 1 to 3, the management microcomputer receives the update state of the firmware at regular time intervals.

### Aspect 5

In the image forming apparatus according to any one of Aspects 2 to 4, when a power button is pressed, the management microcomputer controls shutdown of the main body based on whether at least one of the firmware of the main body and the firmware of the operating device is being updated.

### Aspect 6

In the image forming apparatus according to any one of Aspects 1 to 5, the management microcomputer displays information indicating that the at least one of the firmware of the main body and the firmware of the operating device is being updated on the display, based on the update state.

### Aspect 7

A control method controls an image forming apparatus including a main body, an operating device, a management microcomputer, and a display. The main body can implement image forming function. The operating device receives a user operation. The management microcomputer is communicably connected to the main body and the operating device. The display displays an update state of firmware. The method includes: when at least one of the firmware of the main body and the firmware of the operating device is being updated, receiving information indicating the update state of the firmware; and when at least one of the firmware of the main body and the firmware of the operating device is being updated, controlling display of the display based on the update state.

### Aspect 8

A program causes a computer to perform a method for controlling an image forming apparatus including a main body, an operating device, a management microcomputer, and a display. The main body can implement image forming function. The operating device receives a user operation. The management microcomputer is communicably connected to the main body and the operating device. The display displays an update state of firmware of the main body and an update state of firmware of the operating device. The method includes: when at least one of the firmware of the main body and the firmware of the operating device is being updated, receiving information indicating the update state of the at least one of the firmware of the main body and the firmware of the operating device; and when at least one of the firmware of the main body and the firmware of the operating device is being updated, controlling display of the display based on the update state indicated by the information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a main body to perform image forming operation;
an operating device to receive a user operation;
a management microcomputer communicably connected to the main body and the operating device; and
a display to display an update state of firmware of the main body and an update state of firmware of the operating device,
wherein when at least one of the firmware of the main body and the firmware of the operating device is being updated, the management microcomputer is configured to receive information indicating the update state of the at least one of the firmware of the main body and the firmware of the operating device that is being updated and control displaying operation of the display based on the update state indicated by the information.

2. The image forming apparatus according to claim 1,
wherein the management microcomputer is configured to control shutdown of the main body based on the update state.

3. The image forming apparatus according to claim 1, wherein
the main body and the operating device are directly connected to the management microcomputer by dedicated signal lines,
the main body transmits the information indicating the update state of the firmware of the main body directly to the management microcomputer, and
the operation device transmits the information indicating the update state of the firmware of the operating device directly to the management microcomputer.

4. The image forming apparatus according to claim 1,
wherein the management microcomputer is configured to receive the update states of the firmware of the main body and the firmware of the operating device at regular time intervals.

5. The image forming apparatus according to claim 2,
wherein when a power button for the image forming apparatus is pressed, the management microcomputer is configured to control shutdown of the main body based on whether at least one of the firmware of the main body and the firmware of the operating device is being updated.

6. The image forming apparatus according to claim 1,
wherein the management microcomputer is configured to display information indicating that the at least one of the firmware of the main body and the firmware of the operating device is being updated on the display, based on the update state.

7. A control method of controlling an image forming apparatus including a main body, an operating device, a management microcomputer, and a display,
the main body being configured to perform image forming operation, the operating device being configured to receive a user operation, the management microcomputer communicably connected to the main body and the operating device, and the display being configured to display an update state of firmware of the main body and an update state of firmware of the operating device,
the method comprising:
when at least one of the firmware of the main body and the firmware of the operating device is being updated, receiving information indicating the update state of the at least one of the firmware of the main body and the firmware of the operating device that is being updated; and
when at least one of the firmware of the main body and the firmware of the operating device is being updated, controlling displaying operation of the display based on the update state indicated by the information.

8. A non-transitory storage medium storing computer-readable program code that, when executed by a computer, causes the computer to perform a method of controlling an image forming apparatus including a main body, an operating device, a management microcomputer, and a display,
the main body being configured to perform image forming operation, the operating device being configured to receive a user operation, the management microcomputer communicably connect to the main body and the operating device, and the display being configured to display an update state of firmware of the main body and an update state of firmware of the operating device,
the method comprising:
when at least one of the firmware of the main body and the firmware of the operating device is being updated, receiving information indicating the update state of the firmware that is being updated; and
when at least one of the firmware of the main body and the firmware of the operating device is being updated, controlling displaying operation of the display based on the update state indicated by the information.
